(19) United States
(12) Patent Application Publication
(10) Pub. No.: US 2026/0253487 A1
(43) Pub. Date: Aug. 27, 2026

(54) ANALYSIS SYSTEM, ANALYSIS SYSTEM ANALYSIS METHOD, SERVER DEVICE, SERVER DEVICE CONTROL METHOD, AND PROGRAM

(71) Applicant: Yokogawa Electric Corporation, Musashino-shi, Tokyo (JP)

(72) Inventors: Masayuki Sakata, Musashino-shi, Tokyo (JP); Daisuke Sagae, Musashino-shi, Tokyo (JP); Takayuki Suzuki, Musashino-shi, Tokyo (JP)

(73) Assignee: Yokogawa Electric Corporation, Musashino-shi, Tokyo (JP)

(21) Appl. No.: 19/160,101

(22) PCT Filed: Dec. 20, 2023
(86) PCT No.: PCT/JP2023/045766

§ 371 Date: Aug. 27, 2025

(30) Foreign Application Priority Data
Mar. 1, 2023 (JP) 2023-031437

(51) Int. Cl. G08C 17/00; G01P 15/00

(52) U.S. Cl. CPC G08C 17/00; G01P 15/00

(57) ABSTRACT

An analysis system includes a wireless sensor and a server device that are able to communicate with each other. The wireless sensor includes a first controller that obtains measured values of a physical quantity of a measurement subject measured at predefined measurement times distributed at predefined intervals and transmits the obtained measured values of the physical quantity to the server device. The server device includes a second controller that combines the measured values of the physical quantity measured at measurement times distributed at predefined intervals and received from the wireless sensor, in order to obtain combined information that is time-continuous measurement of the measured values, performs frequency analysis on the combined information, and outputs a result of the frequency analysis of the combined information.

### CROSS-REFERENCE TO RELATED APPLICATION

The present application claims priority to and the benefit of Japanese Patent Application No. 2023-031437 filed Mar. 1, 2023, the entire contents of which are incorporated herein by reference.

### TECHNICAL FIELD

The present disclosure relates to an analysis system, an analysis system analysis method, a server device, a server device control method, and a program.

### BACKGROUND

Techniques for frequency analysis of signals such as Fourier transforms and frequency filters are known (see Patent Literature (PTL) 1 and 2).

Further, small wireless sensors that are battery powered are known. Such wireless sensors measure various physical quantities, such as temperature, pressure, vibration, and the like, and transmit measured values of a physical quantity to other devices via wireless communication.

### CITATION LIST

### Patent Literature

PTL 1: JP 2001-021597 A

PTL 2: JP 2019-035666 A

### SUMMARY

### Technical Problem

When frequency analysis is performed on the measurement results of a wireless sensor and the analysis results are used in another device, the frequency analysis may be performed by the wireless sensor or by another device. Here, in order to perform frequency analysis of a signal, performing arithmetic processing on data across a certain period of time is necessary. Therefore, when a result of frequency analysis of measured values of the physical quantity is to be made available to another device, the wireless sensor must transmit a large amount of data on the measurement results before or after frequency analysis. Transmitting a large amount of data via wireless communication consumes electrical power and may slow down the communication speed of the wireless sensor. In such a case, a conventional configuration transmitting and receiving measured values of a physical quantity measured over only a short period of time depletes the battery of the wireless sensor. In other words, the other device could only use a result of frequency analysis of measured values across a certain short period of time.

Therefore, it would be helpful to enable a result of frequency analysis of measured values measured over a longer period of time by a wireless sensor to be used by another device.

### Solution to Problem

An analysis systems according to at least one embodiment is
(1) An analysis system comprising a wireless sensor and a server device able to communicate with each other, wherein
the wireless sensor comprises a first controller configured to:
obtain measured values of a physical quantity of a measurement subject measured at predefined measurement times distributed at predefined intervals; and
transmit the obtained measured values of the physical quantity to the server device,
the server device comprises a second controller configured to:
combine the measured values of the physical quantity measured at the measurement times distributed at the predefined intervals received from the wireless sensor, to obtain combined information as time-continuous measured values;
perform frequency analysis on the combined information; and
output a result of the frequency analysis of the combined information.

In this way, frequency analysis is performed after combining the measured values of the physical quantity of the measurement subject measured at measurement times distributed at predefined intervals, so that a result of the frequency analysis of the measured values over a longer period of time may be used by another device on the server device side.

According to an embodiment,
(2) in the analysis system according to (1),
the second controller of the server device is configured to perform window function processing on the measured values of the physical quantity measured at the measurement times distributed at the predefined intervals, and combine the measured values for which the window function processing was performed to obtain the combined information.

In this way, the window function is applied and then the measured values are combined to obtain the combined information, thereby helping prevent errors in frequency components due to signal discontinuity.

According to an embodiment,
(3) in the analysis system according to (1) or (2),
the second controller of the server device is configured to transmit a time interval to
the wireless sensor, and
the first controller of the wireless sensor is configured to obtain the measured values of the physical quantity using the time interval received from the server device as the predefined intervals.

In this way, the wireless sensor obtains the measured values of the physical quantity based on the time interval received from the server device, and the time interval for the measurements of the physical quantity may be set by the server device.

According to an embodiment,
(4) in the analysis system according to any one of (1) to (3),
the second controller of the server device is configured to transmit defined times to the wireless sensor, and
the first controller of the wireless sensor is configured to obtain the measured values of the physical quantity using the defined times received from the server device as the measurement times.

In this way, the wireless sensor obtains the measured values of the physical quantity using the defined times received from the server device as the measurement times, and the measurement times for the measured values of the physical quantity may be set by the server device.

According to an embodiment,
(5) in the analysis system according to (1) or (2),
the second controller of the server device is configured to transmit a range of time intervals to the wireless sensor, and
the first controller of the wireless sensor is configured to randomly determine a time interval in the range received from the server device each time the wireless obtains a measured value of the physical quantity, and obtain the measured value of the physical quantity using the randomly determined time interval as the predefined intervals.

In this way, the wireless sensor randomly determines a time interval within a certain range and obtains measured values of the physical quantity at the randomly determined time interval, and therefore missing signals that occur at regular intervals may be avoided.

According to an embodiment,
(6) in the analysis system according to any one of (1) to (5),
the second controller of the server device is configured to transmit a number of measured values to be measured at the measurement times to the wireless sensor, and
the first controller of the wireless sensor is configured to obtain as many measured values of the physical quantity at the measurement times as the number received from the server device.

In this way, the wireless sensor obtains only a number of measured values of the physical quantity set by the server device, thereby allowing the server to set a sampling number of measured values of the physical quantity.

An analysis system analysis method according to at least one embodiment is
(7) an analysis method for an analysis system comprising a wireless sensor and a server device able to communicate with each other, the analysis method comprising:
the wireless sensor
obtaining measured values of a physical quantity of a measurement subject measured at predefined measurement times distributed at predefined intervals, and
transmitting the obtained measured values of the physical quantity to the server device; and
the server device
combining the measured values of the physical quantity measured at the measurement times distributed at the predefined intervals received from the wireless sensor, to obtain combined information as time-continuous measured values,
performing frequency analysis on the combined information, and
outputting a result of the frequency analysis of the combined information.

In this way, frequency analysis is performed after combining the measured values of the physical quantity of the measurement subject measured at measurement times distributed at predefined intervals, so that a result of the frequency analysis of the measured values over a longer period of time may be used on the server device side.

A server device according to at least one embodiment is
(8) a server device comprising a controller capable of communicating with a wireless sensor configured to obtain measured values of a physical quantity of a measurement subject at predefined measurement times distributed at predefined intervals, the controller being configured to:
receive the measured values from the wireless sensor;
combine the measured values of the physical quantity measured at the measurement times distributed at the predefined intervals received from the wireless sensor, to obtain combined information as time-continuous measured values;
perform frequency analysis on the combined information; and
output a result of the frequency analysis of the combined information.

In this way, frequency analysis is performed after combining the measured values of the physical quantity of the measurement subject measured at measurement times distributed at predefined intervals, so that a result of the frequency analysis of the measured values over a longer period of time may be used on the server device side.

A server device control method according to at least one embodiment is
(9) a control method of a server device comprising a controller capable of communicating with a wireless sensor configured to obtain measured values of a physical quantity of a measurement subject at predefined measurement times distributed at predefined intervals,
the controller
receiving the measured values from the wireless sensor;
combining the measured values of the physical quantity measured at the measurement times distributed at the predefined intervals received from the wireless sensor, to
obtain combined information as time-continuous measured values;
performing frequency analysis on the combined information; and outputting a result of the frequency analysis of the combined information.

In this way, frequency analysis is performed after combining the measured values of the physical quantity of the measurement subject measured at measurement times distributed at predefined intervals, so that a result of the frequency analysis of the measured values over a longer period of time may be used on the server device side.

A program according to at least one embodiment is
(10) A program causing a computer capable of communicating with a wireless sensor configured to obtain measured values of a physical quantity of a measurement subject at predefined measurement times distributed at predefined intervals to execute:
a process of receiving the measured values from the wireless sensor;
a process of combining the measured values of the physical quantity measured at the measurement times distributed at the predefined intervals received from the wireless sensor, to obtain combined information as time-continuous measured values;
a process of performing frequency analysis on the combined information; and
a process of outputting a result of the frequency analysis of the combined information.

In this way, frequency analysis is performed after combining the measured values of the physical quantity of the measurement subject measured at measurement times distributed at predefined intervals, so that a result of the frequency analysis of the measured values over a longer period of time may be used on the server device side.

### Advantageous Effect

An embodiment of the present disclosure makes a result of frequency analysis of measured values measured over a longer period of time by a wireless sensor usable by another device.

### BRIEF DESCRIPTION OF DRAWINGS

In the accompanying drawings:

FIG. 1 is a diagram for explanation of frequency analysis by a configuration according to a comparative example;

FIG. 2 is a diagram illustrating an example configuration of an analysis system according to an embodiment;

FIG. 3 is a diagram illustrating a detailed example configuration of some blocks of the analysis system of FIG. 2;

FIG. 4 is a diagram for explanation of frequency analysis by the analysis system of FIG. 2;

FIG. 5 is a flowchart illustrating example operation of the wireless sensor of FIG. 2;

FIG. 6 is a flowchart illustrating example operation of the server device of FIG. 2;

FIG. 7 is a diagram illustrating an example of a signal to be analyzed;

FIG. 8 is a diagram illustrating an example of the signal illustrated in FIG. 7 after frequency analysis; and

FIG. 9 is a diagram illustrating an example of the signal illustrated in FIG. 7 after frequency analysis.

### DETAILED DESCRIPTION

### Comparative Example

An analysis system according to a comparative example includes a wireless sensor that measures a physical quantity, and a server device that receives the measured values of the physical quantity from the wireless sensor and performs defined processing. The wireless sensor measures the physical quantity, performs processing such as analog-to-digital (AD) conversion on the measured values of the physical quantity, and transmits to the server device via low-speed wireless communication. The server device performs the defined processing on the measured values of the physical quantity received from the wireless sensor and outputs to a display or the like. In such a configuration, when frequency analysis such as a Fourier transform is performed on the measurement results of the wireless sensor and an analysis result is used by the server device, the frequency analysis may be performed on the wireless sensor or the server device. In other words, two configurations may be considered: the wireless sensor performs the frequency analysis on the measured values and transmits to the server device, or the wireless sensor does not perform the frequency analysis and transmits the measured values of the physical quantity to the server device, and the frequency analysis is performed on the server device side.

In such configurations, the wireless sensor or the server device performs a fast Fourier transform (FFT). A typical short-term Fourier transform (STFT) is a Fourier transform that applies a shifting window function to the measured values. Here, the wireless sensor or the server device shifts the window function so that the ranges to which the window function is applied overlap each other and processing proceeds so that no time series data is lost. When FFT is performed on the wireless sensor side, in order to reduce the amount of data to be transmitted, the wireless sensor may detect only the peak frequency after processing the FFT and transmit data at that frequency to the server device.

Frequency analysis such as FFT requires arithmetic processing to be performed on data across a certain period of time, and therefore, according to the comparative example, collecting and transmitting a huge amount of data needed for FFT operations or after FFT operations is necessary. As a result, low-speed communication takes a long time to transmit data and increases wireless sensor power consumption. In a configuration where FFT is performed on the wireless sensor side, power consumption increases further due to central processing unit (CPU) arithmetic processing, and a large amount of memory is required. When performing peak frequency extraction and the like, large-capacity memory and power consumption associated with arithmetic operations are further required, and data other than selected data is lost. Even in a configuration using STFT, overlapping or shortening the application ranges of adjacent window functions is common, resulting in power consumption to process and transmit huge amounts of data.

Thus, transmitting a large amount of data by wireless communication consumes power proportional to the amount of data, and may slow down the communication speed of the wireless sensor. In such a case, in the configuration according to the comparative example, transmitting and receiving the measured values of the physical quantity measured only over a short period of time depletes the battery of the wireless sensor. In other words, the server device could only use a result of frequency analysis of measured values across a certain short period of time.

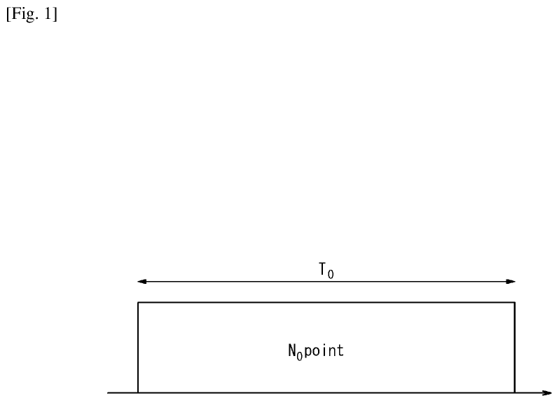

FIG. 1 is a diagram for explanation of frequency analysis by a configuration according to the comparative example. FIG. 1 illustrates an example of a wireless sensor according to the comparative example that transmits No consecutive measured values over a time T₀. Accordingly, the wireless sensor according to the comparative example transmits a large number (No) of consecutive measured values over a certain time T₀ to increase the resolution of the frequency analysis, which alone may deplete the battery power. In other words, in the configuration according to the comparative example, the server device could only use a result of frequency analysis of measured values across a certain short period of time.

Therefore, it would be helpful to enable a result of frequency analysis of measured values measured over a longer period of time by a battery-powered wireless sensor to be used by another device.

### EMBODIMENTS

Embodiments of the present disclosure are described below with reference to the drawings. In each drawing, parts having the same configuration or function are marked with the same reference sign. In description of the embodiments, duplicate descriptions of identical parts may be omitted or simplified as appropriate.

### Analysis system

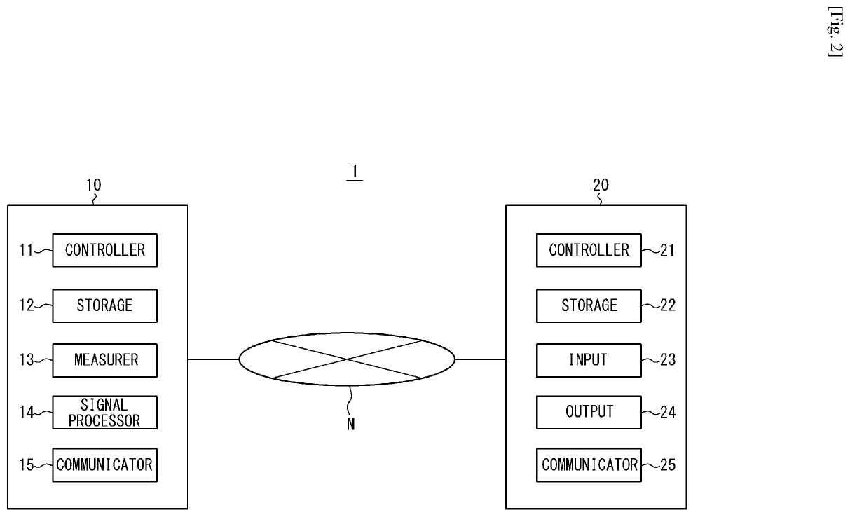

FIG. 2 is a diagram illustrating an example configuration of an analysis system 1 according to an embodiment. The analysis system 1 includes a wireless sensor 10 and a server device 20. The wireless sensor 10 and the server device 20 are communicatively connected to a network N including, for example, the Internet, an intranet, a mobile communication network, and the like.

The wireless sensor 10, for example, measures a physical quantity such as acceleration and transmits measured values of the physical quantity to the server device 20 by wireless communication. The wireless sensor 10 may be battery powered.

According to the present embodiment, the wireless sensor 10 is installed on the measurement subject and measures acceleration of the measurement subject. However, the physical quantity measured by the wireless sensor 10 is not limited to acceleration and may be any physical quantity, for example, temperature, pressure, flow rate, or the like. The wireless sensor 10 collects measured values related to a physical quantity whose state changes over a long period of time. The wireless sensor 10 transmits measured values of the physical quantity to the server device 20 via the network N by a communication method such as LoRa communication, for example.

The server device 20 receives measured values of the physical quantity from the wireless sensor 10, performs frequency analysis such as Fourier transform, and then performs defined processing such as display processing.

In such a configuration, the wireless sensor 10 measures the physical quantity intermittently at regular intervals and transmits a measured value of the physical quantity to the server device 20 for each measurement. Upon receiving measured values of the physical quantity measured intermittently at regular intervals, the server device 20 combines these measured values as measured values measured continuously over time and performs frequency analysis on the combined measured values (combined in-formation). Therefore, according to the present embodiment, it is possible to perform frequency analysis on data reflecting measured values measured over a longer period of time than with conventional configurations. The configuration according to the present embodiment enables more effective frequency analysis when the state of the measurement subject changes over a long period of time.

### Wireless Sensor

As illustrated in FIG. 2, the wireless sensor 10 includes a controller 11, a storage 12, a measurer 13, a signal processor 14, and a communicator 15. The wireless sensor 10 is configured, for example, as a dedicated electronic device, but is not limited to this and some or all components may be configured, for example, as any versatile electronic device, such as a field programmable gate array (FPGA).

The controller (first controller) 11 includes at least one processor. According to the present embodiment, a “processor” may be, but is not limited to, a general-purpose processor or a dedicated processor specialized for particular processing. The controller 11 is communicatively connected to each component of the wireless sensor 10 and controls the overall operation of the wireless sensor 10.

The storage 12 includes any memory module such as read-only memory (ROM), random access memory (RAM), and solid-state drive (SSD), for example. The storage 12 may function, for example, as a main storage device, an auxiliary storage device, or a cache memory. The storage 12 stores any information used in the operation of the wireless sensor 10. For example, the storage 12 may store information such as a measured value of a measured physical quantity and the time of measurement. The controller 11 and the storage 12 may be integrally configured as a microcontroller unit (MCU) or the like. Integrated configuration as an MCU or the like is not limited to the controller 11 and the storage 12. For example, the wireless sensor 10 may be integrally configured with all or any part of the controller 11, the storage 12, the measurer 13, the signal processor 14, and the communicator 15 as an MCU or the like.

The measurer 13 is a sensor that measures a physical quantity related to the measurement subject to obtain measured values. The measurer 13 is, for example, an acceleration sensor, but is not limited to this and may be, for example, a temperature sensor, a pressure sensor, or a flow sensor.

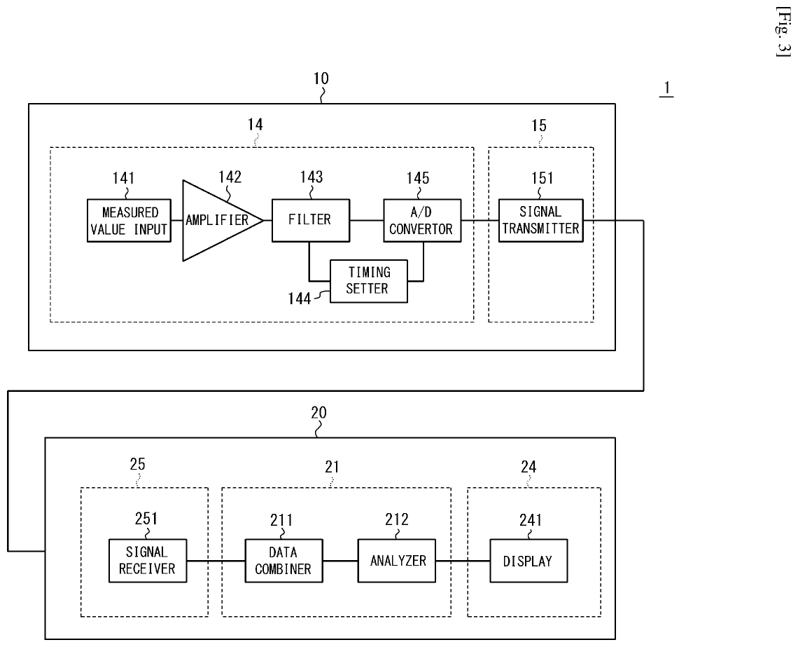

The signal processor 14 analyzes signals of measured values of the physical quantity measured by the measurer 13. Details of the signal processor 14 are described below with reference to FIG. 3.

The communicator 15 includes any communication module for wireless communication with the server device 20 via the network N. According to the present embodiment, the communicator 15 is a communication module for LoRa communication, but is not limited to this type of wireless communication. For example, the communicator 15 may include a communication module for any wireless communication, such as Bluetooth&^{Ograve;} (Bluetooth is a registered trademark in Japan, other countries, or both), near field communication (NFC), wireless local area network (LAN), or the like.

Some or all components of the wireless sensor 10 may be realized by dedicated circuitry included in the controller 11. That is, some or all components of the wireless sensor 10 may be realized by hardware. Alternatively, some or all components of the wireless sensor 10 may be realized by execution of a computer program (program) by a processor in the controller 11. That is, some or all components of the wireless sensor 10 may be realized by software.

FIG. 3 is a diagram illustrating a detailed example configuration of some blocks of the analysis system 1 of FIG. 2. In FIG. 3, components included in the signal processor 14 and the communicator 15 of the wireless sensor 10 are illustrated.

As illustrated in FIG. 3, the signal processor 14 includes a measured value input 141, an amplifier 142, a filter 143, a timing setter 144, and an A/D converter 145. The measured value input 141 obtains signals of measured values of the physical quantity obtained by the measurer 13 via input from the measurer 13. The amplifier 142 amplifies the signals of measured values obtained by the measured value input 141 by a predefined magnification factor. The filter 143 performs a frequency filtering process on the signals of measured values amplified by the amplifier 142 and outputs a signal related to a predefined frequency range of measured values. The A/D converter 145 converts the signal output from the filter 143 from an analog signal to a digital signal. The timing setter 144 sets operation timing of the filter 143 and the A/D converter 145. Specifically, the timing setter 144 may set the sampling period for the A/D converter 145. The timing setter 144 may set the filter 143 to change the filter used according to the sampling period.

The communicator 15 includes a signal transmitter 151. The signal transmitter 151 transmits the signal of measured values in digital format output from the A/D converter 145 to the server device 20 by LoRa communication.

Each of the components included in the signal processor 14 and the communicator 15 described with reference to FIG. 3 is composed of separate and independent hardware, for example. Specifically, each component included in the signal processor 14 and the communicator 15 may be realized as a separate block in an FPGA. Alternatively, each component included in the signal processor 14 and the communicator 15 may be realized by software.

### Server Device

As illustrated in FIG. 2, the server device 20 includes a controller 21, a storage 22, an input 23, an output 24, and a communicator 25. The server device 20 is realized by a general-purpose computer such as a workstation (WS) or personal computer (PC), for example, but may be an FPGA, dedicated electronic device, or the like.

The controller (second controller) 21 includes at least one processor. The controller 21 is communicatively connected to each component of the server device 20 and controls the overall operation of the server device 20.

The storage 22 includes, for example, any storage module such as a hard disk drive (HDD), SSD, ROM, RAM, and the like. The storage 22 may function, for example, as a main storage device, an auxiliary storage device, or a cache memory. The storage 22 stores any information used in operation of the server device 20. For example, the storage 22 may store a system program, an application program, various information received by the communicator 25, and the like. The storage 22 is not limited to being built into the server device 20, and may be an external database or external storage module. For example, the storage 22 may hold measured values of the physical quantity received from the wireless sensor 10.

The input 23 includes at least one input interface that accepts user input operations and obtains input information based on the user input operations. For example, the input 23 may be, but is not limited to, a physical key, a capacitive key, a pointing device, a touch screen integrated with a display of the output 24, or the like.

The output 24 includes at least one output interface that outputs information to a user and notifies the user. For example, the output 24 may be, but is not limited to, a display that outputs information as an image, a speaker that outputs information as sound, or the like. Such a display may be, for example, a liquid crystal panel display, an electro-luminescence (EL) display, or the like. At least one of the input 23 and the output 24 described above may be configured as an integral part of the server device 20, or may be provided as a separate unit.

The communicator 25 includes any communication module that may be connected to another device by any communication technology. The communicator 25 may further include a communication control module for controlling communication with another device and a storage module that stores data for communication such as identification information required for communication with another device.

As illustrated in FIG. 3, the communicator 25 of the server device 20 includes a signal receiver 251. The signal receiver 251 receives signals of measured values transmitted from the wireless sensor 10 via the network N.

The controller 21 includes a data combiner 211 and an analyzer 212. The data combiner 211 accumulates and combines measured values of the physical quantity measured intermittently at regular intervals. The analyzer 212 performs frequency analysis such as a Fourier transform on a signal of measured values (combined in-formation) combined by the data combiner 211.

The output 24 includes a display 241. A signal for which frequency analysis such as a Fourier transform is performed in the analyzer 212 is displayed.

Each component included in the controller 21 described with reference to FIG. 3 is realized, for example, by software. However, at least some of the components of the controller 21 may be realized by dedicated hardware. The display 241 of the output 24 and the signal receiver 251 of the communicator 25 are each composed of hardware, for example. However, at least some of the components included in the output 24 and the communicator 25 may be realized by software.

### Analysis System Operation

As mentioned above, in the analysis system 1 according to the present embodiment, the wireless sensor 10 intermittently measures and transmits to the server device 20 data necessary for a single frequency analysis, unlike a conventional frequency analysis method. The server device 20 performs frequency analysis on a combination of measured values received intermittently from the wireless sensor 10. Accordingly, the server device 20 is able to obtain and use a frequency analysis result that reflects measured values made over a longer period of time than would be possible using a conventional frequency analysis method.

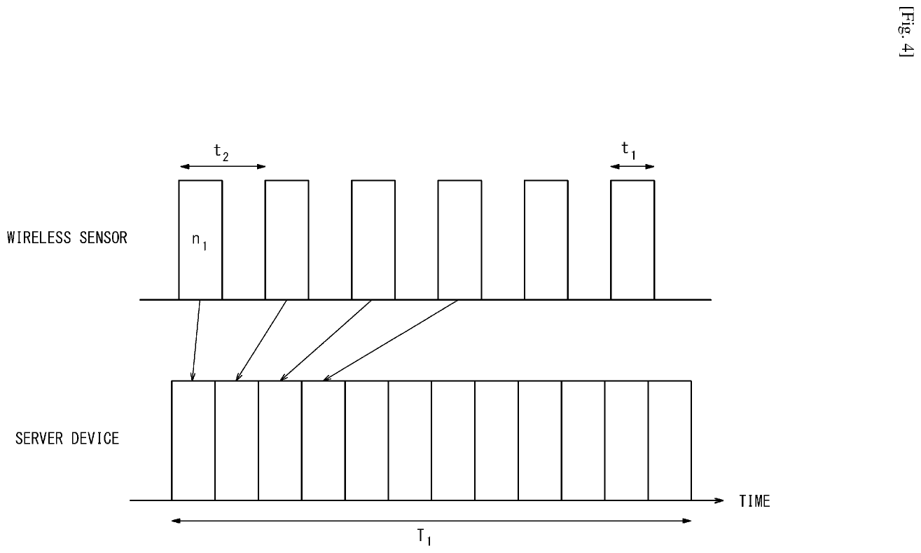

FIG. 4 is a diagram for explanation of frequency analysis by the analysis system 1 of FIG. 2 and FIG. 3. Here, a frequency analysis by the analysis system 1 according to the present embodiment is described in comparison with FIG. 1, which illustrates frequency analysis by a configuration according to the comparative example.

LoRa wide area network (LoRaWAN^{&Ograve;} (LoRaWAN is a registered trademark in Japan, other countries, or both)), a typical low power wide area (LPWA) communication, requires a time on air transmission time of about 400 ms to transmit 11 bytes of data. Here, the time on air transmission time that affects power consumption is considered, and a wait time due to duty cycle limitation that does not affect power consumption is not considered. For example, in the configuration according to the comparative example, when the sampling period of one measurement is T₀ and the number of sampling points is N₀=2048 points, and 2 bytes of information per measured value is assumed, the amount of data to be transmitted is 4096 bytes. As a result, the time on air transmission time Tₐᵢᵣ₀ is 149 s (FIG. 1). For example, assume that the capacity of power stored by the battery of the wireless sensor according to the comparative example is enough power to perform one such communication with a time on air transmission time Tₐᵢᵣ₀=149 s. In this case, the server device according to the comparative example can only use a result of frequency analysis reflecting measured values made in as short a time as 2.048 s.

On the other hand, suppose that in the analysis system 1 according to the present embodiment, for example, the interval between measurements is not changed, the sampling period for one measurement to be obtained is t₁=0.064 s, the number of data points is n₁=64 points, and the information is 2 bytes per measured value. In this case, the time on air transmission time of a measured value from a single measurement is reduced to 4.7 s. Suppose that the wireless sensor 10 repeats such measurements and transmissions 32 times, for example, every t₂=1 day, and for each measurement, the measured value is transmitted to the server device 20. In this case, the server device 20 accumulates and combines the measured values to finally collect data equivalent to &aring;t₁=T₁=2.048 s and &aring;n₁=N₁=2048 data points. In this case, the time on air transmission time Tₐᵢᵣ₁=4.7 s′ 32 =149 s, which is the same as the time on air transmission time Tₐᵢᵣ₀ described for the configuration according to the comparative example. The power consumption of the wireless sensor 10 is proportional to the time on air transmission time. Therefore, assuming that the power capacity stored by the battery of the wireless sensor 10 in the analysis system 1 is the same as that of the wireless sensor of the comparative example, the server device 20 in the analysis system 1 is able to use a result of frequency analysis reflecting measured values measured over 32 days. Thus, according to the analysis system 1 according to the present embodiment, the server device 20 enables use by another device of a result of frequency analysis of measured values measured over a longer period of time than the configuration according to the comparative example.

The measured value data obtained by the server device 20 is incomplete, as illustrated in FIG. 4, but by applying a window function to the signals of measured values for each sampling and then combining and performing a frequency analysis such as Fourier transform, a waveform is obtainable equivalent to a frequency analysis with data collected all at once. The analysis by the analysis system 1 according to the present embodiment is more effective for systems where the frequency of measured values changes when observed over a long period of time due to faults and the like, rather than for systems where the frequency of measured values changes over a short period of time.

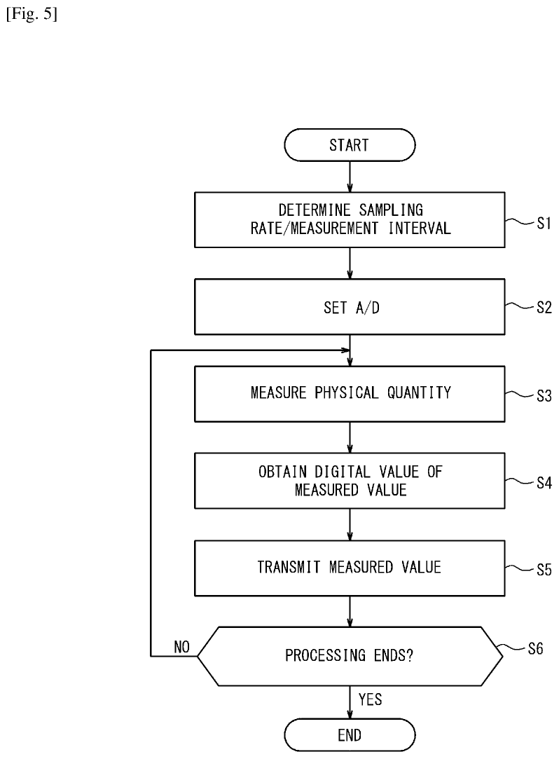

FIG. 5 is a flowchart illustrating example operation of the wireless sensor 10 of FIG. 2. The operation of the wireless sensor 10 described with reference to FIG. 2 may correspond at least in part to the analysis method of the analysis system 1. The operation of each step in FIG. 5 may be performed based on control by the controller 11 of the wireless sensor 10.

In step S1, the controller 11 of the wireless sensor 10 determines the sampling rate and measurement interval. Specifically, the controller 11 may determine the sampling rate and measurement interval in response to a signal from an external device such as the server device 20 or an instruction from a user. The sampling rate is the interval at which measured values are obtained at one measurement time t₁. The measurement interval is the interval t₂ at which one measurement is taken.

In step S2, the controller 11 sets the A/D converter 145. Specifically, the controller 11 sets operation timing according to the sampling rate and measurement interval t₂, as well as the amplitude rate and the like for the A/D converter 145. These settings may be determined in response to a signal from an external device, such as the server device 20, or an instruction from a user.

The controller 11 executes each of the processes from step S3 to step S6 for each measurement interval t₂.

In step S3, the controller 11 controls the measurer 13 to measure the physical quantity of the measurement subject. Specifically, the controller 11 measures the time and physical quantity for the measurement time t₁ at the sampling rate determined in step S1. In this way, the controller 11 obtains n₁ measured values.

In step S4, the controller 11 obtains a digital signal of the measured value of the physical quantity obtained in step S3. Specifically, the controller 11 converts the analog signal of the measured value of the physical quantity into a digital signal by the A/D converter 145, for which operation timing and the like were set in step S2.

In step S5, the controller 11 transmits the digitized measured value signal to the server device 20 by the signal transmitter 151.

In step S6, the controller 11 determines whether to end processing. Specifically, the controller 11 may determine that processing ends based on the elapse of a predefined processing period, an indication by a user that the processing is to end, or remaining battery capacity becoming smaller than a predefined threshold value. When processing is to end (YES in step S6), the controller 11 ends the processing of the flowchart in FIG. 5; otherwise (NO in step S6), the controller 11 resumes processing from step S3 onward after the measurement interval t₂ elapses.

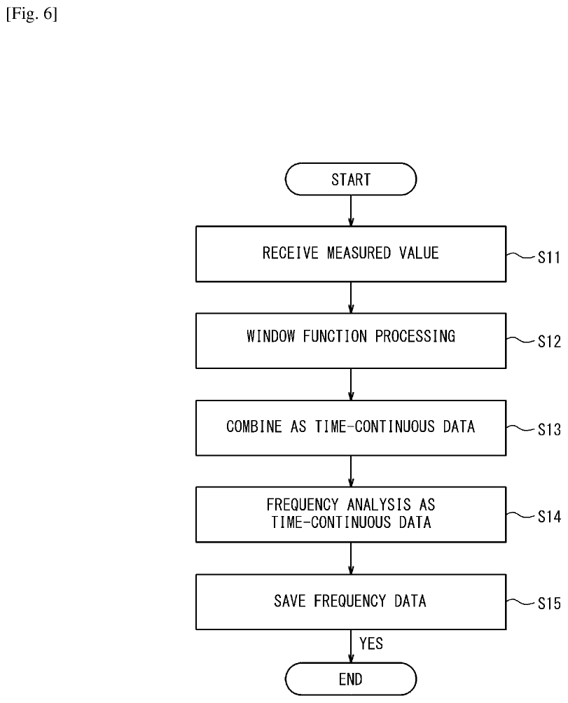

FIG. 6 is a flowchart illustrating example operation of the server device 20 of FIG. 2. The operation of the server device 20 described with reference to FIG. 6 may correspond at least in part to the analysis method of the analysis system 1 or the control method of the server device 20. The operation of each step in FIG. 6 may be performed based on control by the controller 21 of the server device 20.

In step S11, the controller 21 of the server device 20 receives a measured value of the physical quantity from the wireless sensor 10 via the network N. Specifically, the controller 21 receives n₁ measured values measured at measurement time t₁ of FIG. 4.

In step S12, the controller 21 applies a window function to the n₁ received measured values For example, the controller 21 may apply any window function, such as a Hamming window, a Hann window, or a Blackman window, to the measured values.

In step S13, the controller 21 accumulates each measured value to which the window function was applied in steps S11 and S12 and combines the measured values as time-continuous data. Specifically, the controller 21 repeatedly executes steps S11 and S12 to accumulate in the storage 22 the preset number of measured values required for frequency analysis. In step S13, the controller 21 combines the n₁ measured values obtained at each measurement interval t₂ accumulated in the storage 22 and obtains the combined data as data obtained continuously over time.

In step S14, the controller 21 performs frequency analysis on the combined data obtained in step S13 as time-continuous data. The controller 21 may perform frequency analysis using any known method. The frequency analysis performed by the controller 21 is not limited to FFT or Fourier transforms such as STFT, and may be, for example, a frequency filter.

In step S15, the controller 21 outputs the frequency data of the measured values for which frequency analysis was performed in step S14. For example, the frequency data may be saved in the storage 22 or an image of the frequency data may be displayed on the display 241. The controller 21 then ends the processing of the flowchart of FIG. 6.

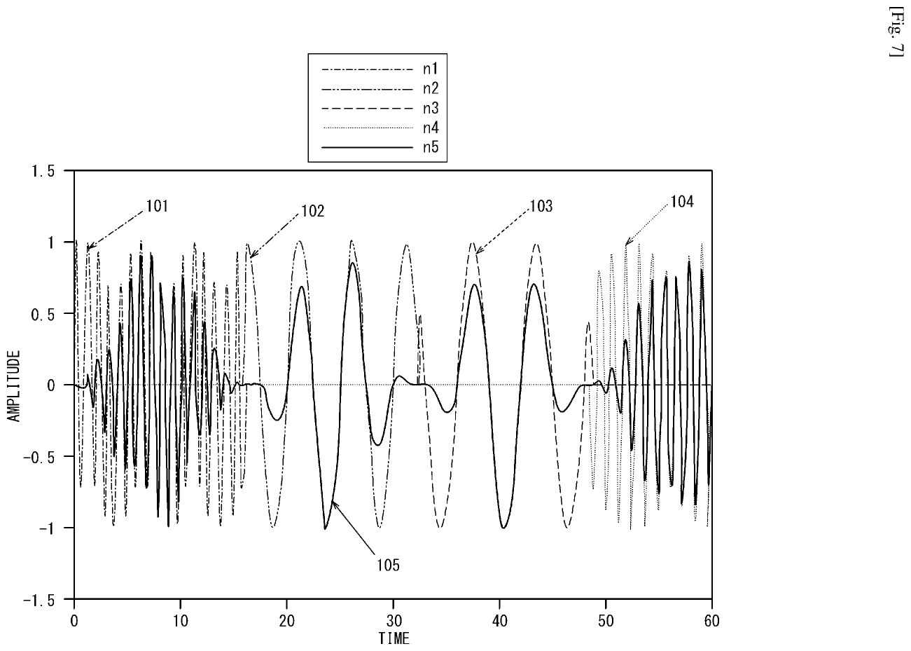

Effects of the analysis processing of the analysis system 1 described in FIG. 4 to FIG. 6 are explained with reference to FIG. 7 to FIG. 9. FIG. 7 is a diagram illustrating an example of a signal to be analyzed. In FIG. 7, graphs 101 to 104 illustrate examples of signals representing measured values of the physical quantity before a window function is applied by the server device 20 by the processing in step 12. Periods of 0 s to 16 s, 16 s to 32 s, 32 s to 48 s, and 48 s to 64 s each correspond to one measurement time t₁. In other words, graphs 101 to 104 as a whole correspond to the combined signal of the physical quantity measured intermittently at regular intervals without application of a window function. Here, the graph 101 represents changes in measured values over the period of 0 s to 16 s. The graph 102 represents changes in measured values over the period of 16 s to 32 s. The graph 103 represents changes in measured values over the period of 32 s to 48 s. The graph 104 represents changes in measured values over the period of 48 s to 64 s. Graph 105 represents changes in measured values after applying a window function to each of the periods 0 s to 16 s, 16 s to 32 s, 32 s to 48 s, and 48 s to 64 s, with respect to the graphs 101 to 104 connected together.

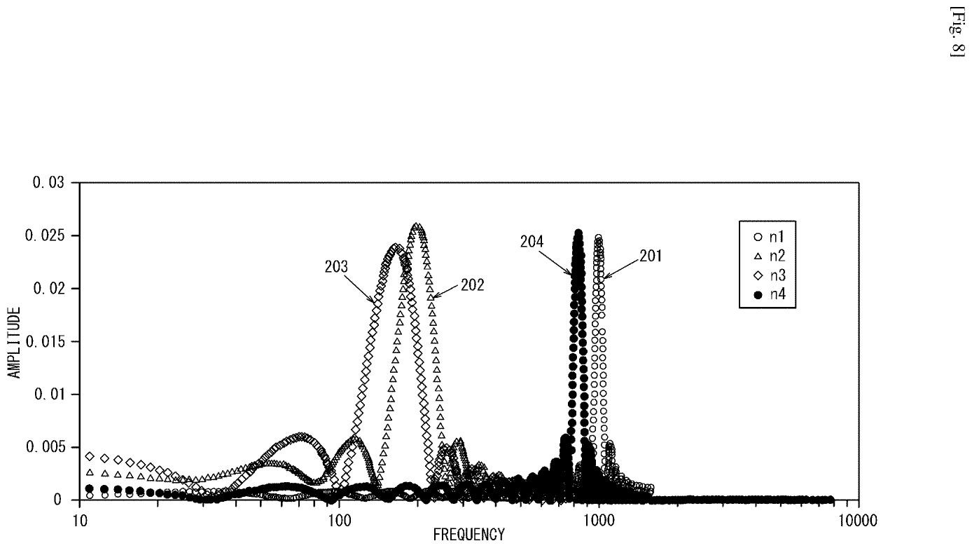

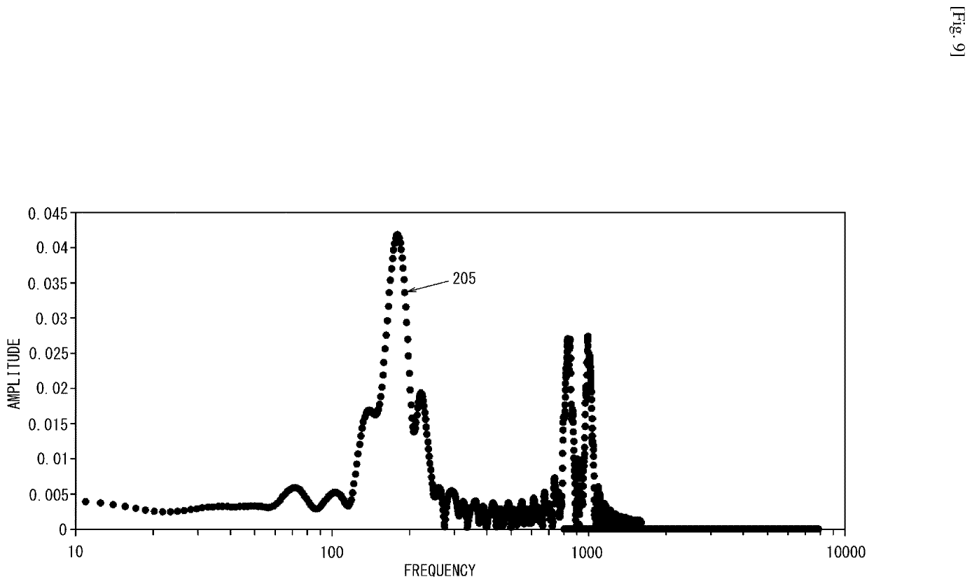

FIG. 8 and FIG. 9 illustrate examples of the signal illustrated in FIG. 7 after Fourier transform. In FIG. 8, graph 201 is a graph representing frequency components of the graph 101, obtained by Fourier transformation of the signal of the graph 101 of FIG. 7. Graph 202 is a graph representing frequency components of the graph 102, obtained by Fourier transformation of the signal of the graph 102. Graph 203 is a graph representing frequency components of the graph 103, obtained by Fourier transformation of the signal of the graph 103. Graph 204 is a graph representing frequency components of the graph 104, obtained by Fourier transformation of the signal of the graph 104. In other words, the graphs 201 to 204 represent signals after frequency analysis obtained by the configuration according to the comparative example. However, in the configuration according to the comparative example, a signal after frequency analysis obtained on the server device side by a single measurement is any one of the graphs 201 to 204. For example, when the battery of the wireless sensor is depleted by one measurement, as in the example described above with reference to FIG. 1 and FIG. 4, a server device is able to use only one of the graphs 201 to 204, according to the comparative example.

In contrast, the graph 205 in FIG. 9 represents frequency components of the graph 105, obtained by Fourier transformation of the signal of the graph 105 of FIG. 7. As mentioned above, the graph 105 is a combination of the graphs 101 to 104 after applying a window function to each, so the graph 205 represents a signal after frequency analysis obtained by the analysis system 1 according to the present embodiment. As is clear from comparing the graphs 201 to 204 in FIG. 8 with the graph 205 in FIG. 9, the graph 205 indicates waveforms that reflect the distribution of frequency components throughout the graphs 201 to 204. Specifically, the graph 205 has a waveform that allows a user to recognize global distribution of each peak frequency in the graphs 201 to 204. Therefore, according to the analysis system 1, the server device 20 is able to use the results of frequency analysis of measured values measured over a longer period of time when compared to the configuration according to the comparative example where the wireless sensor 10 performs processing consuming the same amount of power as the wireless sensor of the comparative example. In other words, in the configuration according to the comparative example, when the analyzed waveform changes over a long period (for example, on a daily or monthly basis), the server device is only able to acquire waveforms at individual points in time and is unable to perform analysis including waveform changes. In contrast, in the analysis system 1 according to the present embodiment, the server device 20 is able to perform analysis including such long-period changes. Further, in the analysis system 1, the server device 20 is able to obtain information such as peak frequency and amplitude of each waveform obtained at individual time points according to the comparative example.

As described above, the analysis system 1 includes the wireless sensor 10 and the server device 20 that are able to communicate with each other. The wireless sensor 10 obtains measured values of the physical quantity of the measurement subject measured at predefined measurement times distributed at predefined intervals and transmits the obtained measured values of the physical quantity to the server device 20. The server device 20 combines the measured values of the physical quantity measured at measurement times distributed at predefined intervals and received from the wireless sensor 10, in order to obtain combined information that is time-continuous measurement of the measured values, performs frequency analysis on the combined information, and outputs a result of the frequency analysis of the combined information. In this way, the analysis system 1 performs frequency analysis after combining the measured values of the physical quantity of the measurement subject measured at measurement times distributed at predefined intervals. Accordingly, a result of frequency analysis of measured values measured over a longer period of time is usable by another device on the server device side.

The server device 20 performs window function processing on the measured values of the physical quantity measured at measurement times t₁ distributed at predefined intervals, and combines the measured values for which the window function processing was performed to obtain combined information (combined measured values). Accordingly, the window function is applied and then the measured values are combined to obtain the combined information, thereby helping prevent errors in frequency components due to signal discontinuity.

In the analysis system 1 according to the present embodiment, by setting a longer time as the measurement time t₁ and using a window function for a longer time, the resolution at low frequencies may be improved without changing the number of measured values, that is, the power consumption of the wireless sensor 10.

In the analysis system 1, the number of measured values measured at a given point in time is smaller than in the configuration according to the comparative example. As a result, the frequency range that may be analyzed may be narrowed, and the server device 20 may not be able to acquire data in a frequency range for which analysis is desired. To avoid such a situation, the analysis system 1 may change a window width without changing the number of data points by downsampling (sampling again at a lower frequency). Further, a transmitted data number (n₁) sent from the wireless sensor 10 may be changed based on an instruction from the server device 20 so that the server device 20 is able to measure a desired frequency range. Window width information may be sent from the wireless sensor 10 to the server device 20 so that the server device 20 is able to perform analysis according to the window width.

Further, the measurement interval t₂ of the wireless sensor 10 may be set from an external device such as the server device 20. That is, the server device 20 may transmit the desired time interval to the wireless sensor 10. The wireless sensor 10 may obtain measured values of the physical quantity using a time interval (measurement interval t₂) received from the server device 20 as the predefined intervals. For example, the wireless sensor 10 including an accelerometer could be attached to a rotating machine such as a motor, and frequency analysis of an integer multiple of the rotation speed of the rotating machine could be performed. Thus, when frequency changes that occur periodically are known in advance, a measurement interval corresponding to that period may be set for the wireless sensor 10 from the server device 20 or the like. Further, the measurement interval t₂ is not a fixed value, and may be set to change randomly within a certain range.

For example, the server device 20 may transmit a time interval range (for example, upper and lower limits of the time range) to the wireless sensor 10, and the wireless sensor 10 may randomly determine the time interval t₂ within that range each time the wireless sensor 10 obtains a measured value of the physical quantity. Alternatively, the server device 20 may randomly determine the time interval t₂ for each time interval t₂ and instruct the wireless sensor 10 to use the determined time interval t₂. For example, in order to capture frequency changes that occur irregularly, setting the measurement interval t₂ to random makes effectively analyzing such frequency changes possible.

Further, in the example described above, window function processing takes place in the server device 20, but the window function processing may be performed on the wireless sensor 10 side. When window function processing is performed by the server device 20, rectangular window function processing may be performed on the wireless sensor 10 side.

Further, the server device 20 may combine the waveforms of a time series of received measured values and display a result on the display 241, as illustrated by the graph 105 in FIG. 7, without frequency analysis processing such as FFT. Further, the server device 20 may analyze a signal received from the wireless sensor 10 frequency analysis processing such as a Fourier transform.

When the server device 20 has not received a sufficient number of measured values for frequency analysis, the server device 20 may perform analysis by setting the measured values in an interval with insufficient data to a fixed value such as 0 or a representative value such as the average of measurements received up to that point. For example, the server device 20 may perform such processing when 32 measurement time t₁ measured values are to be collected to create data for time T₁, but only 10 measurements have been received. Further, the server device 20 may change the number of data points to collect. For example, the server device 20 may combine 32 measured values for analysis and also combine 8 measured values for analysis at the same time.

Further, the wireless sensor 10 may be configured to be driven by energy harvesting technology such as vibration power generation instead of a battery. Alternatively, the wireless sensor 10 may be any device that is connected to a stable power source but requires low power consumption.

The present disclosure is not limited to the embodiments described above. For example, multiple blocks illustrated in a block diagram may be integrated, or one block may be split. Instead of being executed in chronological order according to the description, multiple steps described with reference to a flowchart may be executed in parallel or in a different order, depending on processing capability of the device performing each step or as required. Other changes are possible without departing from the spirit of the present disclosure.

### REFERENCE SIGNS LIST

1 analysis system
10 wireless sensor
11 controller
12 storage
13 measurer
14 signal processor
141 measured value input
142 amplifier
143 filter
144 timing setter
145 A/D converter
15 communicator
151 signal transmitter
20 server device
21 controller
211 data combiner
212 analyzer
22 storage
23 input
24 output
241 display
25 communicator
251 signal receiver
101-105 graphs
201-205 graphs
N network

1. An analysis system comprising a wireless sensor and a server device able to communicate with each other, wherein
the wireless sensor comprises a first controller configured to:
obtain measured values of a physical quantity of a measurement subject measured at predefined measurement times distributed at predefined intervals; and
transmit via a first communicator the obtained measured values of the physical quantity to the server device,
the server device comprises a second controller configured to:
combine the measured values of the physical quantity measured at the measurement times distributed at the predefined intervals received from the wireless sensor, to obtain combined information as time-continuous measured values;
perform frequency analysis on the combined information; and
output a result of the frequency analysis of the combined information.

2. The analysis system according to claim 1, wherein the second controller of the server device is configured to perform window function processing on the measured values of the physical quantity measured at the measurement times distributed at the predefined intervals, and combine the measured values for which the window function processing was performed to obtain the combined information.

3. The analysis system according to claim 1, wherein
the second controller of the server device is configured to transmit via a second communicator a time interval to the wireless sensor, and
the first controller of the wireless sensor is configured to obtain the measured values of the physical quantity using the time interval received from the server device as the predefined intervals.

4. The analysis system according to claim 1, wherein
the second controller of the server device is configured to transmit via a second communicator a range of time intervals to the wireless sensor, and
the first controller of the wireless sensor is configured to randomly determine a time interval in the range received from the server device each time the wireless obtains a measured value of the physical quantity, and obtain the measured value of the physical quantity using the randomly determined time interval as the predefined intervals.

5. The analysis system according to claim 1, wherein
the second controller of the server device is configured to transmit via a second communicator defined times to the wireless sensor, and
the first controller of the wireless sensor is configured to obtain the measured values of the physical quantity using the defined times received from the server device as the measurement times.

6. The analysis system according to claim 1, wherein
the second controller of the server device is configured to transmit via a second communicator a number of measured values to be measured at the measurement times to the wireless sensor, and
the first controller of the wireless sensor is configured to obtain as many measured values of the physical quantity at the measurement times as the number received from the server device.

7. An analysis method for the analysis system according to claim 1, the analysis method comprising:
the wireless sensor
obtaining measured values of a physical quantity of a measurement subject measured at predefined measurement times distributed at predefined intervals, and
transmitting the obtained measured values of the physical quantity to the server device; and
the server device
combining the measured values of the physical quantity measured at the measurement times distributed at the predefined intervals received from the wireless sensor, to obtain combined information as time-continuous measured values,
performing frequency analysis on the combined information, and
outputting a result of the frequency analysis of the combined information.

8. A server device comprising a controller capable of communicating with a wireless sensor configured to obtain measured values of a physical quantity of a measurement subject at predefined measurement times distributed at predefined intervals, the controller being configured to:
receive the measured values from the wireless sensor;
combine the measured values of the physical quantity measured at the measurement times distributed at the predefined intervals received from the wireless sensor, to obtain combined information as time-continuous measured values;
perform frequency analysis on the combined information; and
output a result of the frequency analysis of the combined information.

9. A control method of the server device according to claim 8,
the controller
receiving the measured values from the wireless sensor;
combining the measured values of the physical quantity measured at the measurement times distributed at the predefined intervals received from the wireless sensor, to obtain combined information as time-continuous measured values;
performing frequency analysis on the combined information; and
outputting a result of the frequency analysis of the combined information.

10. A non-transitory computer-readable storage medium storing a program causing a computer capable of communicating with a wireless sensor configured to obtain measured values of a physical quantity of a measurement subject at predefined measurement times distributed at predefined intervals to execute:
a process of receiving the measured values from the wireless sensor;
a process of combining the measured values of the physical quantity measured at the measurement times distributed at the predefined intervals received from the wireless sensor, to obtain combined information as time-continuous measured values;
a process of performing frequency analysis on the combined information; and
a process of outputting a result of the frequency analysis of the combined information.
